(19) United States
(12) Patent Application Publication
(10) Pub. No.: US 2005/0094482 A1
(43) Pub. Date: May 5, 2005

(54) Method and apparatus for producing closed cell foam

(75) Inventors: John R. Foster JR., Duluth, GA (US); Leslie J. Varga, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 10/969,701

(22) Filed: Oct. 20, 2004

Related U.S. Application Data
(60) Provisional application No. 60/516,368, filed on Oct. 31, 2003.

(51) Int. Cl. B01F 13/02

(52) U.S. Cl. 366/101; 264/50

(57) ABSTRACT

Methods and apparatus for producing high quality closed cell foams for use in applications such as coatings, sealant beads, seam filling and gaskets is provided. A two-stage mixing unit, having a static mixing stage comprising a static mixer having a plurality of mixing elements followed immediately by a second dynamic stage such as a dynamic gear pump or disc mixer is used to homogeneously disperse a gas throughout a highly viscous liquid polymeric material such as a plastisol, silicone, butyl or urethane based materials.

This application claims the benefit of U.S. Provisional Application No. 60/516,368 filed on Oct.31, 2004, the disclosure of which is hereby incorporated by reference herein.

### FIELD OF THE INVENTION

The present invention relates to methods and apparatus for mixing a gas with a liquid polymeric material to produce a closed cell foam structure such as a foam coating or bead. More particularly, the invention is suitable for use with polymeric materials such as adhesives, sealants and caulks.

### BACKGROUND OF THE INVENTION

The assignee of this invention pioneered the development and application of methods and apparatus for foaming hot melt thermoplastic adhesives as well as other polymeric materials such as sealants and caulks. Hot melt adhesives are widely used throughout industry for adhering substrates one with another in many diverse applications, including the packaging and cartoning industries. With respect to hot melt adhesives, for example, the assignee of this invention discovered that the adhesive strength of a bond achieved with a given volume of a selected hot melt adhesive could be appreciably improved and in most instances at least doubled if the adhesive were applied as a foam rather than as a conventional non-foamed adhesive. The increased bonding strength of the foamed adhesive results at least in part from the fact that the adhesive foam may be spread over at least twice the area, under the same compressive conditions, as an equal mass of adhesive which has not been foamed. These and other discoveries are disclosed in Scholl et al. U.S. Pat. No. 4,059,714 (the '714 patent), Scholl et al. U.S. Pat. No. 4,059,466, and Akers et al. U.S. Pat. No. 4,200,207, all of which are assigned to the assignee of this application.

As shown in those patents, in producing a hot melt adhesive foam, if a gas such as air or nitrogen is thoroughly mixed with liquid hot melt adhesive, the gas can go into solution in the adhesive. When the adhesive/gas solution is subsequently dispensed, as from a conventional valve type of adhesive dispenser or gun, the gas will come out of solution but remain entrapped in the adhesive, to form a closed cell hot melt adhesive foam having the desirable adhesive characteristics described above.

Other polymeric materials such as sealants, caulks and other adhesive materials also have enhanced properties when employed in the form of a foam. Foamed sealants or caulks may, for example, be provided by injecting air or nitrogen into the material prior to delivery to the dispensing device. The materials used for foam sealants or caulks are typically substances having medium to high viscosity, often formed from bulk material which is supplied to the material dispensing device. In such a system, the material is sometimes moderately heated to enhance its flow and setting properties, and is sometimes heated to higher temperatures to produce a hot melt flowable material from a solid thermoplastic material supplied in bulk to the system.

The foam material is formulated in a foam material dispensing system by mixing the liquid material with compressed gas before it is dispensed in foamable form, as, for example, before dispensing an adhesive onto a part. In the foam dispensing system, the gas and the material are maintained under pressure so that the gas, which may be approximately 1/10th of one percent by weight of the adhesive mixture, is dissolved or otherwise contained in the mixture such that there is no more than a negligible change in volume from that of the material alone. When dispensed at atmospheric pressure, however, the gas in the mixture expands producing a foamed material of a density that has been reduced by the increased volume of the added expanded gas. The process of foaming these higher viscosity materials and the apparatus for doing so are described in the commonly assigned patent by Cobbs, Jr. et al. U.S. Pat. No. 4,778,631 (the '631 patent).

The types and quality of foamed polymeric material produced by the methods and apparatus of the present invention are generally similar to those produced by the apparatus of the type disclosed in the '631 patent. The apparatus disclosed in the '631 patent is a dynamic mixer which was developed to address the very difficult problem of homogeneously mixing two different materials having very divergent viscosities, or in other words, having an extremely high viscosity ratio. More specifically, it deals with the problem of homogeneously mixing a gas which essentially has a viscosity near zero with liquid polymers having viscosities ranging from about 2,000 centipoise (cps) up to, for example, 1,000,000 cps to produce high quality closed cell foam. Although the dynamic mixer of the '631 patent also works well with polymers having lower ranges of viscosities, it is disclosed as being especially useful and advantageous for mixing gas with liquid polymer having viscosities in the range of 50,000 cps to above 1,000,000 cps.

The dynamic mixer of the '631 patent produces a very high quality closed cell foam such as foamed plastisol which may be used to form a gasket or as a coating such as an auto body undercoating or as a bead for other sealing purposes. The high quality of the closed cell foam produced by the dynamic mixer of the '631 patent is characterized by the homogeneous dispersion of microbubbles of gas which remain trapped within the polymeric material after it has been dispensed from the mixer and has cured or set. Prior to the introduction of dynamic mixers of the type disclosed in the '631 patent, apparatus incorporating gear pumps had been utilized to foam hot melt adhesives which range in viscosity from about 2,200 cps to 20,000-35,000 cps at the usual dispensing temperatures of about 350° F. to 400° F. One example of this type of apparatus is disclosed in the '714 patent.

The '631 patent addressed some of the shortcomings of gear pump mixers, especially with respect to the inability to obtain adequate mixing with polymers having viscosities above 50,000 cps, however, the dynamic mixers of the type disclosed in the '631 patent have significant drawbacks related to their cost effectiveness and practicality in certain applications. Most notably, these mixers are relatively bulky and complex in design due to their large number of moving parts. Therefore, they may be relatively difficult to set up especially where space considerations are a significant factor and, perhaps more importantly, are expensive to manufacture and therefore costly to the end user. Also, the cost of maintenance and repair remains high throughout the life of the mixers due to their relatively complex design.

Alternate mixing devices were designed to mix liquid polymers with gas including static mixers that effectively use no moving parts to create a homogeneous solution of polymeric material and gas. One such disclosure is U.S. Pat. No. 4,396,529 (the '529 patent) to Price et al., being assigned to the assignee of the present invention. The '529 patent discloses a dispensing head including a static mixing means preferably comprising four baffle plates disposed directly upstream of the dispensing head discharge orifice. Pressurized gas is injected into a contact chamber containing pressurized liquid hot melt adhesive immediately upstream of the four baffle plates. As the liquid hot melt adhesive and gas are caused to flow through the baffle plates, the mixture is divided and then recombined to distribute the gas within the adhesive.

Although the device disclosed in the '529 patent performs satisfactorily when used in conjunction with many liquids, and specifically hot melt adhesives having much lower viscosities than the materials used in, for example the dynamic mixer of the '631 patent mentioned above, testing has shown that higher viscosity liquid polymers having viscosities above about 3,000 cps cannot be formed into high quality foams with the dispensing head of the '529 patent. More specifically, when plastisols having viscosities on the order of 3,000 cps and above are run through the dispensing head disclosed in the '529 patent, inadequate dispersion of the gas within the plastisol results in low quality foam which is unsuitable for many applications. Thus, the dispensing head of the '529 patent is not suited for producing the high quality foamed polymeric material which is produced by the dynamic mixer of the '631 patent mentioned above.

A static mixer design was also disclosed in U.S. Pat. No. 5,480,589 to Belser et al. (the '589 patent) that could effectively mix a gas with a moderately to highly viscous liquid polymer, such as that disclosed by the '631 patent. This mixer used an in-line static mixing device containing a very large number of individual mixing elements to homogeneously disperse a gas throughout a highly viscous liquid polymer. Using conventional mixing elements such as that, for example, disclosed in U.S. Pat. No. 4,527,712 issued to Cobbs, Jr. et al. and assigned to the assignee of the present invention, having alternating right and left-handed helices, approximately 90 such elements had to be used to produce a high quality foam. Additionally, alternate static mixing element designs, other than the helical design, were disclosed but were also found to require a large number of elements to achieve an acceptable foam. This design not only requires appreciable costs and appreciable space due to the large number of elements required to produce a high quality foam, but also requires the pressure of the liquid material to be significantly increased in order to push the liquid through the large number of mixing elements.

In view of the above noted problems in the prior art, there is a need for improvements in the formation of high quality closed cell foam from higher viscosity polymers, and specifically for improvements which increase the efficiency, reliability and cost effectiveness of producing such high quality closed cell foams.

### SUMMARY OF THE INVENTION

The present invention comprises methods and apparatus for producing high quality closed cell foams for use and applications such as bonding, coatings, sealant beads, seam filling and gaskets. Specifically, the invention concerns forming these high quality closed cell foams from viscous polymers having viscosities in excess of about 1,000 cps and more preferably, 3,000 cps. The present invention utilizes a two-stage mixing device. The first stage is a static mixing device and the second stage is a dynamic mixing device, which may, for example, take the form of a dynamic gear pump, that together homogeneously disperse a gas throughout a highly viscous liquid polymeric material such as a plastisol, silicone, butyl or urethane base material. A two-stage mixing device provides several advantages not seen in a purely dynamic or purely static mixing system. Such a two-stage mixer produces a high quality foam from highly viscous polymers and a wide range of flow rates through the mixer. The result is a closed cell foam which comprises a homogeneous dispersion or solution of similarly sized microbubbles of gas within a polymeric matrix.

As used herein, the term “solution” describes the liquid polymer containing a dissolved gas supplied under high pressure to the mixing unit which creates a foamed polymeric structure when dispensed at atmospheric pressure. The term “solution” as used in the specification and claims of the application is intended to define and encompass the broader generic definition of solution which is a homogeneous mixture of a gas and a molten or liquid polymer, whether or not all the gas molecules are in fact dissolved or dispersed among the polymer molecules, but where the gas is not present as a bubble, in sizes which are equal to or larger than the polymer molecule size. A gas and polymeric mixture that does not satisfy the definition of solution as stated above is simply referred to as a mixture.

The invention more specifically comprises a pressurized bulk material source for force feeding highly viscous liquid polymer into a mixing unit. Gas at a pressure above the pressure of the polymer material is also injected into the mixing unit. A nozzle or dispensing gun is attached to the conduit downstream of the mixing unit and may be designed according to specific application requirements to dispense the solution in the form of, for example, a bead or spray coating. Specific applications of the present invention include those in which the dynamic mixer of the '631 patent is presently used such as auto body undercoating and sound proofing applications and other sealing applications such as gasket production. The mixing unit comprises a first stage static mixer comprising a conduit having a plurality of mixing elements. Although the static mixer provides a substantial portion of the mixing to achieve a homogeneous solution, due to the relatively small number of mixing elements used in the present invention, the gas and polymeric material that exits the static mixer tends to have bubble sizes that are larger than the molecules of the polymeric material. Thus to achieve a fully homogenous solution, the mixture exiting the first stage static mixer is run through a second stage dynamic mixer.

The second stage mixer is configured to break these larger gas bubbles up into smaller gas bubbles, therefore becoming a homogeneous solution as defined herein. An advantageous aspect of the two-stage mixing device is that the dynamic mixer may take the form of a dynamic gear pump or disc mixer which is much simpler in design and operation as compared to the current dynamic mixers, such as those of the '631 patent. A heated hose may further be provided between the exit of the booster and the dispensing gun. The heated hose not only makes the material more flowable between the second stage mixer and the dispensing gun, but the heated hose also drives the gas further into solution providing a more homogenous solution and more consistent foam.

The two-stage mixing unit as described in the present invention has several advantages. For example, high quality closed cell foam coatings and beads may be applied using apparatus and methods of the present invention in many diverse applications while avoiding the relatively high cost associated with dynamic mixers currently in use. In particular, dynamic mixers used in the present invention do not utilize the expensive and complex mechanical face seals of previous dynamic mixers, but instead use cheaper, more reliable, and less complex lip seals. The present invention can be used to homogeneously mix gas into viscous liquid polymeric materials to form closed cell foams thus eliminating or significantly reducing major costs associated with the manufacture, repair, maintenance and clean up of prior dynamic mixers used to produce many of the same closed cell foams.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a block diagram of a foam dispensing system which may use the mixing apparatus constructed in accordance with the present invention;

FIG. 2 is a block diagram of a mixing unit having a first stage static mixer followed by a second stage dynamic mixer and including a heated hose;

FIG. 3 is a partially broken away cross-sectional view of a plurality of static mixing elements within a conduit to form a static mixer;

FIG. 4 is a cross-sectional view of a gear pump used as the second stage dynamic mixer;

FIG. 5 is a cross-sectional view of a disc mixer used as the second stage dynamic mixer.

FIG. 5A is a cross-sectional view of the disc mixer of FIG. 5 taken along line 5A-5A.

### DETAILED DESCRIPTION

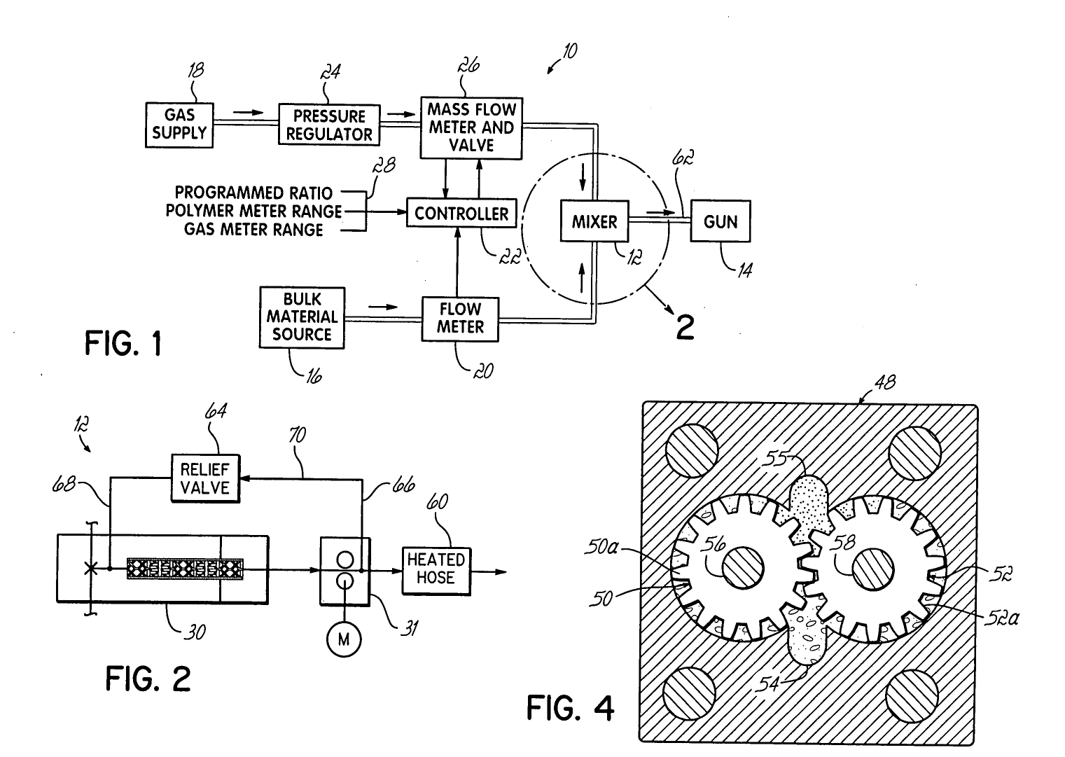

Referring to FIG. 1 a foam dispensing system 10 is illustrated and comprises a suitable system in which the mixing unit of the present invention may be incorporated. Except for mixing unit 12, the general configuration of the system 10 is shown and described in more detail in U.S. Pat. No. 5,056,034 issued to Rucki et al. and which is assigned to the assignee of the present invention and hereby incorporated by reference herein in its entirety. The system 10 controls gas and polymer flow to a mixing unit 12 constructed according to the present invention, as further explained below. The mixing unit 12 delivers a solution of the polymer and gas to a dispensing gun 14 after receiving and mixing liquid polymeric material and gas, respectively, from a bulk material source 16 and gas supply 18. The system 10 further includes a digital flow meter 20, a controller 22 as well as a pressure regulator 24 and a mass flow meter and valve 26. The digital flow meter 20 produces output pulses to the controller 22 and the controller 22 further processes signals from the mass flow meter and valve 26 as detailed in U.S. Pat. No. 5,056,034. The controller 22 is a microprocessor based control device having a set of inputs 28 which accept settings from the operator including a setting for the programmed ratio of gas to polymer, the polymer meter range and the gas meter range.

FIG. 2 illustrates a mixing unit 12 according to the present invention comprising a two-stage mixing system. The first stage is a static mixing stage being a static mixer 30 comprising a plurality of static mixing elements. This static stage is followed immediately by a second stage that completes the mixing process. The second stage comprises a dynamic mixer 31 which may take the form of a dynamic gear pump 48 or alternatively a dynamic disc mixer 49. The two-stage mixing unit provides the advantages that relatively few static mixing elements have to be used in the static mixer and a smaller, less complex dynamic mixer can be utilized to achieve a homogeneous solution of dispersed gas in a viscous polymeric material.

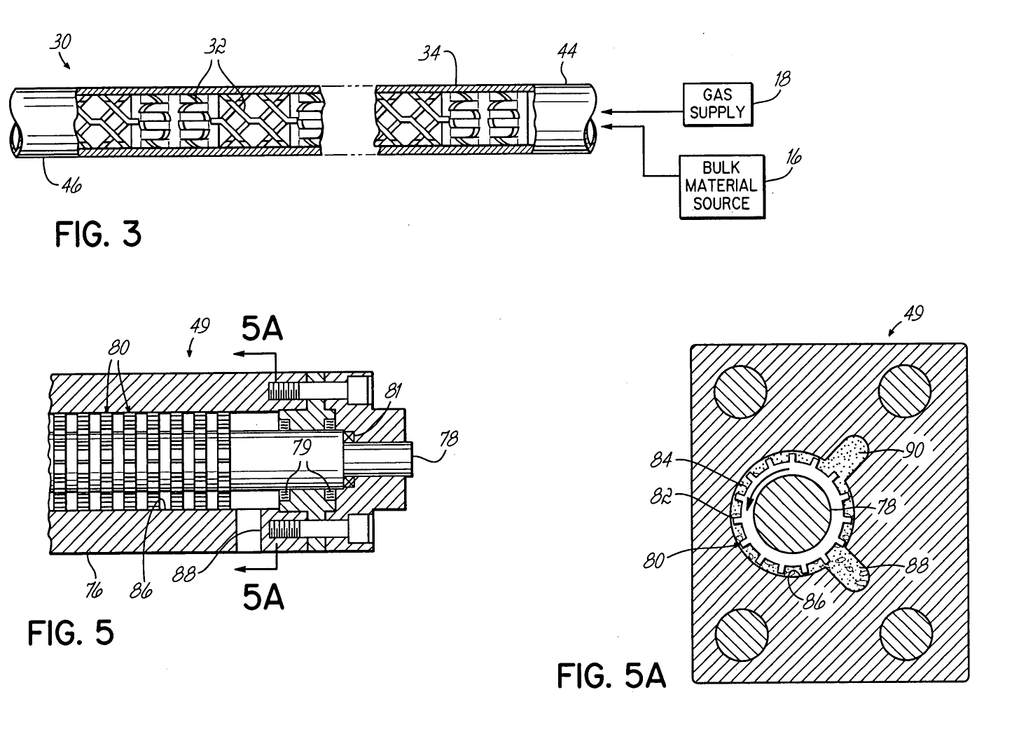

The static mixer of the present invention, is substantially that described in U.S. Pat. No. 5,480,589 issued to Belser et al., assigned to the assignee of the present invention, and incorporated by reference herein in its entirety. In accordance with that disclosure, FIG. 3 illustrates a static mixer 30 according to an embodiment of the present invention and including a plurality of static mixing elements 32 contained within a conduit 34. FIG. 3 illustrates the static mixer 30 broken away to show a representative series of elements 32 as well as a representative length conduit 34. Elements, such as those illustrated in FIG. 3 are commercially available and are sold by Sulzer Ltd, of Switzerland under the SMX series of mixers. Other mixing elements, such as those disclosed in the '589 patent, could also be used to comprise static mixer 30.

To obtain high quality closed cell foam, the actual minimum number of elements, such as the SMX elements similar to that shown in FIG. 3 is at least 3 elements with better results being obtained using between 4 and 8 elements. The exact number of elements will vary depending on the material being foamed.

An inlet 44 of the conduit 34 is connected to a pressurized bulk material source 16 for force feeding polymeric material into conduit 34. Also, pressurized gas from a gas supply 18 is injected into conduit 34, in accord with the system of FIGS. 1-2. For plastisols and urethanes, such as Dynafoam, the polymer should be supplied at a pressure greater than 1000 psi and preferably at a pressure of between about 1400 psi and about 3000 psi. The gas is supplied at a pressure of about 100 psi higher than the polymer supply pressure to prevent the material from filling the gas supply line.

The static mixer 30 completes a substantial portion of the mixing of the viscous polymeric material and the gas. With the limited number of mixing elements used in the static stage static mixer, however, a solution is not yet achieved between the polymeric material and the gas, i.e., a number of large gas bubbles exist throughout the mixture that if left unchecked, would lead to “coughing” or “spitting” at the dispensing gun during the dispensing operation. When these large gas bubbles are discharged from the outlet of the dispensing gun, they disrupt the uniform output of the foamed material.

To prevent this undesirable result, the opposed exit 46 of conduit 34 of the static mixer 30 is immediately connected to a second stage dynamic mixer. The dynamic mixer is configured to break the large gas bubbles up and drive the gas into solution with the polymeric material. The dynamic mixer is further configured to produce a homogeneous dispersion of small gas bubbles throughout the solution so as to provide a uniform foam upon dispensing from the dispensing gun 14. As shown in FIG. 4, one embodiment of the dynamic mixer is a gear pump 48. Gear pumps are well known in the art and are commercially available.

In reference to FIG. 4, an illustrative single stage gear pump 48 is shown. The gear pump 48 has intermeshing gears 50, 52 having teeth 50(a) and 52(a), respectively that operate as multiple small pistons to pull the incoming polymeric material/gas mixture into the pump, pressurize it, and dispense it from the pump outlet 55. The intermeshing gears 50, 52 also serve to mix the polymeric material and gas together so as to eliminate the large gas bubbles remaining after the static mixer. In the illustrated embodiment, the polymeric material/gas mixture is supplied to the pump inlet 54 from the exit 46 of the static mixer 30. The two intermeshing gears 50, 52 of the pump 48 are mounted on a pair of parallel shafts 56, 58. One of these shafts 56 is driven by a motor, as for example, a pneumatic motor (not shown), while the other 58 is an idler shaft.

FIG. 5 shows an alternate embodiment for the dynamic mixer. The disc mixer comprises a housing 76 having a shaft 78 therethrough and along the axis of the housing. The shaft 78 is driven by a motor (not shown). The shaft provides a series of spaced discs 80 which are substantially perpendicular to the axis of the shaft 78. The discs 80 have a series of spaced teeth 82 on the outer circumference separated by slots 84 and extend substantially almost to the inner wall 86 of the housing 76. Shaft 78 is sealed by simple ring shaped seals 79, such as lip seals, and supported for rotation by a bearing 81. Operation of the motor causes rotation of the shaft 78, which in turn rotates the spaced discs 80 and movement of the teeth 82 and slots 84 relative to the fixed housing inner wall 86. In the illustrated embodiment, the polymeric material/gas mixture is supplied to the disc mixer inlet 88 from the exit 46 of the static mixer 30. The teeth 82 and the shearing action between the slots 84 and inner wall 86 mix the polymeric material and gas so as to eliminate the large bubbles remaining after the static mixer. The solution leaves disc mixer 49 through exit 90 to be dispensed through dispenser 14. Because a substantial portion of the mixing has been achieved with the static mixer 30, smaller, less complex dynamic mixers 48, 49 can be used in the present invention to complete the mixing process.

The mixing unit of the present invention may further include a heated hose 60 disposed in conduit 62 between the outlet of the dynamic mixer, such as gear pump 48, and the dispensing gun 14. The heated hose 60 serves a dual purpose. One purpose is to facilitate the movement of the viscous solution through the conduit connecting the mixing unit 12 and the dispensing gun 14. Heating the solution decreases the viscosity of the solution making it more flowable, thus reducing the pressure losses in the conduit and preventing the gas from coming out of solution before being dispensed in the dispensing gun 14. Furthermore, heated hose 60 increases the overall pressure in conduit 62 which drives the gas further into solution with the polymeric material. Thus, longer heated hoses 60 are more desirable and provide better results than shorter hoses or no hose at all.

The mixing unit may also further include a pressure relief valve 64 having an inlet 66 immediately downstream of the dynamic mixer 31. Relief valve 64 has an outlet 68 upstream of the static mixer 30. The pressure relief valve 64 is configured such that if the pressure immediately downstream of the dynamic mixer 31 rises above a certain level, as determined for the application, the valve is opened and the solution flows through conduit 70 and back to the inlet of the static mixer 30. In this way, the pressure does not build up to where the mixing unit 12, the conduits 62, 70, or the dispensing gun 14 are damaged.

The basic operation of the embodiment of the present invention is described with respect to FIGS. 3-4. Liquid polymeric material such as plastisol is forced fed into the inlet end 44 of the conduit 34 by the pressurized bulk source 16 at a pressure above 1,000 psi and preferably in the range of 1,400 psi-3,000 psi. At the same time, gas such as air, nitrogen or carbon dioxide is force fed into the inlet end 44 of conduit 34 and through the static mixing elements 32 which continuously divide the gas and polymeric material forming a mixture with some remaining larger gas bubbles. The mixture from the static mixer 30 then flows through the dynamic gear pump 48 to mix the gas/viscous material mixture until the gas is homogeneously dispersed throughout the liquid polymeric material in the form of microbubbles. The solution then flows through a conduit 62 having a heated hose 60 and to the dispensing gun 14, from which the solution is dispensed to form a high quality closed cell foam.

Several advantages over the prior art are obtained by way of the present invention. For example, high quality closed cell foam coatings and beads may be applied using apparatus and methods of the present invention in many diverse applications while avoiding the relatively complex systems and related high cost associated with dynamic mixers currently in use. Specifically, a two-stage mixing unit eliminates the sealing problems associated with the conventional dynamic mixtures. In conventional dynamic mixers for mixing highly viscous polymeric materials, leaks often occur due to the pressures developed in the mixers, the large drive shafts required to operate the mixers, and the rates at which the drive shafts are operated. These dynamic mixers require costly and highly complex mechanical face seals to prevent leakage of gas and liquid polymeric material from the mixer. Moreover, as is known to those skilled in the art, mechanical face seals also require additional structures and support systems such as additional sealing members, bearing housings and air or oil pumping systems to flush the face seal and provide required pressurization within the seal. These systems also require additional control systems to monitor the face seals in operation.

By utilizing the two-stage mixer of the present invention, these complicated mechanical face seals and their additional related sub-systems can be completely eliminated from the dynamic stage of the mixing system. A smaller and simpler dynamic mixer, such as a gear pump or disc mixer, can now be utilized to achieve the second stage mixing. Advantageously, the dynamic mixers of the present invention do not require any mechanical face seals, but instead use less expensive, less complex, and more reliable lip seals to seal the smaller drive shafts extending through the mixer. Eliminating the face seals of the traditional dynamic mixers, such as those used in the '631 patent, eliminates the major costs associated with the manufacture, repair, maintenance and clean-up of prior mixing systems used to produce many of the closed cell foams that may be produced by the present invention.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. An apparatus, including a mixing unit for producing a closed cell foam from a gas and a viscous polymeric material, the mixing unit comprising:
static mixer having an inlet adapted for coupling to a source of the viscous polymeric material and to a source of the gas, and an outlet;
a dynamic mixer having an inlet coupled to said outlet of said static mixer and an outlet for dispensing a solution of the viscous polymeric material and the gas.

2. The apparatus of claim 1 wherein said static mixer comprises at least three mixing elements arranged in series in a conduit.

3. The apparatus of claim 1 wherein said dynamic mixer comprises a gear pump.

4. The apparatus of claim 1 wherein said dynamic mixer comprises a disc mixer.

5. The apparatus of claim 1 further comprising:
a pump connected to said mixing unit for delivering the polymeric material at a pressure through said mixing unit; and
a pressurized gas supply connected to said mixing unit for injecting the gas into the polymeric material within said mixing unit downstream of said pump.

6. The apparatus of claim 5 wherein said static mixer comprises at least three mixing elements arranged in series in a conduit.

7. The apparatus of claim 5 wherein said dynamic mixer comprises a gear pump.

8. The apparatus of claim 5 wherein said dynamic mixer comprises a disc mixer.

9. The apparatus of claim 5, further comprising a dispensing unit, and a heated hose, coupled to said outlet of said dynamic mixer and to said dispensing unit.

10. The apparatus of claim 5, further comprising a pressure relief valve having a first portion fluidly connected to said inlet of said static mixer, and a second portion fluidly connected to said outlet of said dynamic mixer.

11. An apparatus comprising:
a source of pressurized viscous polymeric material;
a source of pressurized gas;
a static mixer having an inlet coupled to said source of viscous polymeric material and to said source of gas, and an outlet;
a dynamic mixer having an inlet coupled to said outlet of said static mixer and an outlet for dispensing a solution of the viscous polymeric material and the gas.
a flow meter fluidly coupled between said source of pressurized viscous polymeric material and said static mixer;
a gas control valve fluidly coupled between said source of pressurized gas and said static mixer;
a controller for controlling the amount of gas injected into said static mixer, said controller receiving signals from said flow meter, said controller sending signals to said gas control valve to inject an amount of gas into said static mixer based upon an amount of viscous polymeric material being supplied to said static mixer; and,
a dispenser coupled to said dynamic mixer for dispensing the foamable solution.

12. The system of claim 11 wherein said static mixer comprises at least three mixing elements arranged in series in a conduit.

13. The system of claim 11 wherein said dynamic mixer comprises a gear pump.

14. The system of claim 11 wherein said dynamic mixer comprises a disc mixer.

15. The system of claim 11 further comprising a dispensing unit coupled with a heated hose, said heated hose adapted to receive the solution and deliver the solution to said dispensing unit.

16. The system of claim 11 further comprising a pressure relief valve having a first portion fluidly connected to an inlet of said static mixer, and a second portion fluidly connected to an outlet of said dynamic mixer.

17. A method of producing a closed cell foam by mixing a gas with a liquid polymeric material within a mixing unit to form a solution, the method comprising:
force feeding the polymeric material to an inlet of the mixing unit at a pressure;
injecting a pressurized gas into the inlet of the mixing unit;
directing the gas and polymeric material through a plurality of static mixing elements to form a mixture; and then directing the mixture through a dynamic mixer to achieve the solution.

18. The method of claim 17 wherein directing the mixture through a dynamic mixer further comprises directing the mixture through a gear pump.

19. The method of claim 17 wherein directing the mixture through a dynamic mixer further comprises directing the mixture through a disc mixer.

20. The method of claim 17 wherein delivering the polymeric material further comprises delivering at least one of plastisols, silicones, butyls, and urethanes.

21. The method of claim 17 wherein delivering the gas further comprises delivering at least one of nitrogen, carbon dioxide, and air.

22. The method of claim 17 wherein directing the gas and polymeric material through the static mixing elements further comprises directing the gas and polymeric material through between at least three mixing elements.

23. The method of claim 17 wherein force feeding the polymeric material to the inlet of the mixing unit further comprises at least one of the following: a) feeding the polymeric material to the inlet of the mixing unit at a pressure above approximately 1,000 psi; b) injecting the gas into the inlet of the mixing unit at a pressure above approximately 1,000 psi; and c) feeding the polymeric material having a viscosity above approximately 10,000 cps to the inlet of the mixing unit.

24. The method of claim 17 further comprising directing the solution from the dynamic mixer through a heated hose to a dispensing unit.

25. The method of claim 17 further comprising directing the solution through a pressure relief line when the pressure downstream of the dynamic mixer reaches a certain value.
